(19) United States
(12) Patent Application Publication
(10) Pub. No.: US 2026/0264016 A1
(43) Pub. Date: Sep. 10, 2026

(54) IN-SITU REGENERATION OF FILTER MEDIUM FOR IMPROVING CATALYTIC EFFICIENCY

(71) Applicant: W. L. Gore & Associates, Inc., Newark, DE (US)

(72) Inventors: Monaca A. McNall, Newark, DE (US); Jeffrey A. Kolde, Avondale, PA (US); Tarun K. Poddar, Kennesaw, GA (US)

(21) Appl. No.: 19/165,655

(22) PCT Filed: Mar. 12, 2024
(86) PCT No.: PCT/US2024/019514

§ 371 Date: Sep. 16, 2025

Related U.S. Application Data
(60) Provisional application No. 63/452,947, filed on Mar. 17, 2023.

(51) Int. Cl. B01D 53/96; B01D 39/08; B01D 46/00; B01D 46/02; B01D 46/82; B01D 53/86; B01D 53/88

(52) U.S. Cl. CPC B01D 53/96; B01D 39/083; B01D 46/0027; B01D 46/023; B01D 46/82; B01D 53/8625; B01D 53/88; B01D 2251/104; B01D 2251/106; B01D 2251/2062; B01D 2257/302; B01D 2258/0283

(57) ABSTRACT

Various aspects of the present disclosure are directed towards apparatuses, systems, and methods of regenerating a filter medium for use in cleaning flue gas stream. The method may include increasing NOx removal efficiency of the filter medium by increasing the upstream NO₂ concentration, wherein increasing the upstream NO₂ concentration includes oxidizing NO to form additional NO₂ outside the flue gas stream, and introducing the additional NO₂ into the flue gas stream.

### CROSS-REFERENCE TO RELATED APPLICATION

This application is a national phase application of PCT Application No. PCT/US 2024/019514, internationally filed on Mar. 12, 2024, which claims the benefit of Provisional Application No. 63/452,947, filed Mar. 17, 2023, which are incorporated herein by reference in their entireties for all purposes.

### FIELD

The present disclosure relates generally to apparatuses, systems, and methods of cleaning a flue gas stream. More specifically, the disclosure relates to apparatuses, systems, and methods of regenerating a filter medium for use in cleaning a flue gas stream.

### BACKGROUND

Coal-fired power generation plants, municipal waste incinerators, and oil refinery plants generate large amounts of flue gases that contain substantial varieties and quantities of environmental pollutants, nitrogen oxides (NOx compounds), mercury (Hg) vapor, and particulate matters (PM). In the United States, burning coal alone generates about 27 million tons of SO₂ and 45 tons of Hg each year. Thus, there is a need for improvements to methods for removing NOx compounds, sulfur oxides, mercury vapor, and fine particulate matters from industrial flue gases, such as coal-fired power plant flue gas.

### SUMMARY

Catalytic filter medium or filter bags may be used to remove NOx in flue gas streams. During the selective reduction (SCR) of NOx, ammonium bisulfate (ABS, NH₄HSO₄) may be produced that covers the catalyst-active sites and may shorten the catalyst lifespan.

The present disclosure generally relates to a method for regenerating the catalytic filter medium or filter bags in-situ by removing the formed ABS and recover the catalytic performance. The method depends on NO₂ being present in the flue gas stream while it passes through the catalytic filter bag. In some embodiments, the method includes increasing the upstream NO₂ concentration via introducing an oxidizing agent into the flue gas stream. In certain embodiments, the method includes introducing NO₂ into the flue gas stream in addition to the oxidizing agent. In some embodiments, the method includes mixing NO with an oxidant outside the flue gas duct to form NO₂, then injecting the mixed gas containing NO₂ into the flue gas duct upstream of the baghouse.

According to one embodiment (“Embodiment 1”), a method includes providing at least one filter medium; flowing a flue gas stream transverse to a cross-section of the at least one filter medium, such that the flue gas stream passes through the cross section of the at least one filter medium; and increasing NOx removal efficiency of the at least one filter medium. The at least one filter medium may include at least one catalyst material; and ammonium bisulfate (ABS) deposits, ammonium sulfate (AS) deposits, or any combination thereof. The flue gas stream may include NOx compounds including: Nitric Oxide (NO), and Nitrogen Dioxide (NO₂). In some embodiments, the increasing of the NOx removal efficiency of the at least one filter medium includes increasing an upstream NO₂ concentration to a range from 2% to 99% of a total concentration of the upstream NOx compounds. In certain embodiments, the increasing the upstream NO₂ concentration to a range from 2% to 99% of a total concentration of the upstream NOx compounds includes: providing an NO stream; oxidizing the NO stream with at least one oxidizing agent to form additional NO₂, and introducing the additional NO₂ into the flue gas stream.

Embodiment 2 is the method of Embodiment 1, wherein the NO stream is oxidized prior to being introduced into the flue gas stream.

Embodiment 3 is the method of any preceding Embodiment, wherein the providing the NO stream includes removing at least some of the NO from the flue gas stream and selectively filtering the at least some of the NO from the flue gas stream to obtain the NO stream.

Embodiment 4 is the method of any preceding Embodiment, wherein the increasing the upstream NO₂ concentration to a range from 2% to 99% of a total concentration of the upstream NOx compounds further includes: introducing additional oxidizing agent into the flue gas stream.

Embodiment 5 is the method of any preceding Embodiment, wherein the method regenerates the at least one filter medium.

Embodiment 6 is the method of any preceding Embodiment, wherein oxidizing the NO stream with at least one oxidizing agent to form additional NO₂ is at a temperature of from −20° C. to 280° C.

Embodiment 7 is the method of any preceding Embodiment, wherein the at least one oxidizing agent is hydrogen peroxide (H₂O₂), ozone (O₃), hydroxyl radical, an organic peroxide, a metal peroxide, a peroxy-acid, or any combination thereof.

Embodiment 8 is the method of any preceding Embodiment, wherein the oxidizing the NO stream includes reacting the NO stream with an excess amount of the at least one oxidizing agent.

Embodiment 9 is the method of any preceding Embodiment, wherein a temperature of the flue gas stream ranges from 80° C. to 450° C. during the flowing step.

Embodiment 10 is the method of Embodiment 9, wherein the temperature of the flue gas stream ranges from 160° C. to 280° C.

Embodiment 11 is the method of any preceding Embodiment, wherein the flue gas stream further includes Oxygen (O₂), Water (H₂O), Nitrogen (N₂), Carbon Monoxide (CO), Sulfur Dioxide (SO₂), Sulfur Trioxide (SO₃), one or more hydrocarbons, one or more particulates or any combination thereof.

Embodiment 12 is the method of any preceding Embodiment, wherein flowing the flue gas stream transverse to the cross-section of the at least one filter medium includes flowing the flue gas stream perpendicular to the cross-section of the at least one filter medium.

Embodiment 13 is the method of any preceding Embodiment, wherein the at least one filter medium is disposed within at least one filter bag, wherein the at least one filter bag is housed within at least one filter bag housing, and wherein the at least one catalyst material is in the form of catalyst particles.

Embodiment 14 is the method of Embodiment 13, wherein the at least one filter medium includes: a porous protective layer; and a porous catalytic layer, wherein the porous catalytic layer includes the catalyst particles.

Embodiment 15 is the method of Embodiment 14, wherein the porous protective layer of the at least one filter medium includes a microporous layer, wherein the microporous layer includes an expanded polytetrafluoroethylene (ePTFE) membrane.

Embodiment 16 is the method of Embodiment 14, wherein the porous catalytic layer of the at least one filter medium includes at least one polymeric substrate.

Embodiment 17 is the method of Embodiment 14, wherein the porous catalytic layer includes at least one ceramic substrate.

Embodiment 18 is the method of Embodiment 14, wherein the porous catalytic layer includes polytetrafluorethylene (PTFE), poly(ethylene-co-tetrafluoroethylene) (ETFE), ultra-high molecular weight polyethylene (UHMWPE), polyparaxylylene (PPX), polylactic acid, polyimide, polyamide, polyaramid, polyphenylene sulfide, fiberglass, or any combination thereof.

Embodiment 19 is the method of Embodiment 14, wherein the catalyst particles are enmeshed within the porous catalytic layer.

Embodiment 20 is the method any of Embodiments 14 to 19, wherein the porous catalytic layer is in the form of a layered assembly including: a porous catalytic film; and at least one felt batt, wherein the at least one felt batt is positioned on at least one side of the porous catalytic film.

Embodiment 21 is the method of Embodiment 20, wherein the porous catalytic film includes an expanded polytetrafluoroethylene (ePTFE) membrane.

Embodiment 22 is the method of Embodiment 20, wherein the at least one felt batt includes: a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, or any combination thereof.

Embodiment 23 is the method of any preceding Embodiment, wherein the at least one catalyst material includes at least one of: Vanadium Monoxide (VO), Vanadium Trioxide (V₂O₃), Vanadium Dioxide (VO₂), Vanadium Pentoxide (V₂O₅), Tungsten Trioxide (WO₃), Molybdenum Trioxide (MoO₃), Titanium Dioxide (TiO₂), Silicon Dioxide (SiO₂), Aluminum Trioxide (Al₂O₃), Manganese Oxide (MnO₂), zeolites, or any combination thereof.

Embodiment 24 is the method of any preceding Embodiment, wherein ABS deposits are disposed on the catalyst material of the at least one filter medium in a concentration ranging from 0.01% to 99% by mass of the at least one filter medium during the providing step.

Embodiment 25 is the method of any preceding Embodiment, wherein, after increasing the upstream NO₂ concentration to a range from 2% to 99% of a total concentration of the upstream NOx compounds, ABS deposits are disposed on the catalyst material of the at least one filter medium in a concentration ranging from 0.01% to 98% by mass of the at least one filter medium.

Embodiment 26 is the method of any preceding Embodiment, wherein the at least one oxidizing agent is O₃.

Embodiment 27 is the method of any preceding Embodiment, wherein the at least one oxidizing agent is H₂O₂.

Embodiment 28 is the method of any preceding Embodiment, wherein the increasing of the NOx removal efficiency further includes removing at least some of the ABS deposits, the AS deposits, or any combination thereof, from the at least one filter medium.

Embodiment 29 is the method of any preceding Embodiment, further including adding ammonia (NH₃) to the flue gas stream.

Embodiment 30 is the method of Embodiment 29, wherein the NH₃ added has a concentration ranging from 0.0001% to 0.5% of a concentration of the flue gas stream.

Embodiment 31 is a method including: providing at least one filter medium; flowing a flue gas stream transverse to a cross-section of the at least one filter medium, such that the flue gas stream passes through the cross section of the at least one filter medium from an upstream side of the filter medium to a downstream side of the filter medium; and maintaining a NOx removal efficiency of the at least one filter medium in an amount of at least 50% of an initial NOx removal efficiency of the at least one filter medium by: providing an NO₂ concentration, measured from the upstream side of the filter medium, in a range from 2% to 99% of a total concentration of the NOx compounds, and controlling the NO₂ concentration, measured from the downstream side of the filter medium, to a range of from 0.0001% to 0.5% of the concentration of the flue gas stream. In some embodiments, the at least one filter medium includes at least one catalyst material. In some embodiments, the flue gas stream includes NOx compounds including: Nitric Oxide (NO), and Nitrogen Dioxide (NO₂); Sulfur Dioxide (SO₂); and Ammonia (NH₃). In some embodiments, providing the NO₂ concentration, measured from the upstream side of the filter medium, in a range from 2% to 99% of a total concentration of the NOx compounds includes: providing an NO stream; oxidizing the NO stream with at least one oxidizing agent to form additional NO₂, and introducing the additional NO₂ into the flue gas stream.

Embodiment 32 is the method of any of the preceding Embodiments, wherein the method cleans the flue gas stream.

Embodiment 33 is the method of any of the preceding Embodiments, wherein the at least one filter medium includes a porous catalytic fluoropolymer film having an upstream side and a downstream side, wherein the porous catalytic fluoropolymer film includes a plurality of perforations, wherein each of the plurality of perforations is a straight passageway from an entrance surface at the upstream side of the porous catalytic fluoropolymer film to an exit surface at the downstream side of the porous catalytic fluoropolymer film. In some embodiments, the straight passageway is configured to enhance flow therethrough as compared to flow via the pores of the material, and the straight passageway has a diameter of 0.1 mm to 3 mm. In some embodiments, a percent open area of the porous catalytic fluoropolymer film is from 0.14% to 50%.

Embodiment 34 is a system including at least one filter medium, at least one filter bag, and at least one filter bag housing. The at least one filter medium may include an upstream side; a downstream side; at least one catalyst material; and ammonium bisulfate (ABS) deposits, ammonium sulfate (AS) deposits, or any combination thereof. The at least one filter medium may be disposed within the at least one filter bag, and the at least one filter bag may be disposed within the at least one filter bag housing. In some embodiments, the at least one filter bag housing is configured to receive a flow of a flue gas stream transverse to a cross-section of the at least one filter medium, such that the flue gas stream passes through the cross section of the at least one filter medium from the upstream side of the at least one filter medium to the downstream side of the at least one filter medium, wherein the flue gas stream includes: NOx compounds including: Nitric Oxide (NO), and Nitrogen Dioxide (NO₂). In some embodiments, the system is configured to increase an NOx removal efficiency of the at least one filter medium when an upstream NO₂ concentration is increased to a range from 2% to 99% of a total concentration of the upstream NOx compounds. In some embodiments, increasing the upstream NO₂ concentration to a range from 2% to 99% of a total concentration of the upstream NOx compounds includes: providing an NO stream; oxidizing the NO stream with at least one oxidizing agent to form additional NO₂, and introducing the additional NO₂ into the flue gas stream.

The foregoing Embodiments are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A-1D depict exemplary filter mediums in accordance with embodiments of the present disclosure.

FIG. 2 is a flow diagram of a method for regenerating filter medium in accordance with embodiments of the present disclosure.

FIG. 3 is a flow diagram of a method for regenerating filter medium in accordance with embodiments of the present disclosure.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

As used herein, the term “flow through” means that a flue gas stream is flowed transverse to a cross section of the at least one filter medium, such that the flue gas stream passes through a cross section of the at least one filter medium. In some embodiments of a “flow through” configuration, the flue gas stream is flowed perpendicular to a cross-section of the at least one filter medium.

As used herein, the term “flow by” means that the flue gas stream is not flowed transverse to a cross section of the at least one filter medium, such that the flue gas does not pass through the cross section of the at least one filter medium. In some embodiments of a “flow by” configuration, the flue gas stream is flowed parallel to a cross-section of the at least one filter medium.

As used herein “upstream” refers to a location of a flue gas stream before entering a filter medium. In the “flow through” context, “upstream” may refer to the location of a flue gas stream before entering a cross section of a filter medium. In the “flow by” context, “upstream” may refer to the location of a flue gas stream before entering an enclosure (e.g., a housing, a filter bag, or other suitable enclosure described herein) that contains a filter medium.

As used herein “downstream” refers to a location of a flue gas stream after exiting a filter medium. In the “flow through” context, “downstream” may refer to the location of a flue gas stream after exiting a cross section of a filter medium. In the “flow by” context, “downstream” may refer to the location of a flue gas stream after exiting an enclosure (e.g., a housing, a filter bag, or other suitable enclosure described herein) that contains a filter medium.

As used herein, the term “NOx compound” refers to any oxide of nitrogen. In some non-limiting embodiments, “NOx compound” may specifically refer to gaseous oxides of nitrogen that are known environmental pollutants.

As used herein, the term “catalytic composite article” set forth in the Examples refers to any material that includes a combination of at least one catalyst material and at least one additional material according to any embodiment described herein. The additional material is not limited to any particular type of material and may be, for example, a membrane, a felt batt, a ceramic substrate (including but not limited to a ceramic candle), a honeycomb substrate, a monolith substrate, or any combination thereof. The catalytic composite article may, in some non-limiting examples, be a porous catalytic film.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

As mentioned above, catalytic filter medium or filter bags may be used to remove NOx in flue gas streams. During the selective reduction (SCR) of NOx, NH₃ may be applied as the reducing agent to react with NOx to form N₂ and H₂O. Sulfur dioxide (SO₂) in the flue gas may be oxidized by the SCR to sulfur trioxide (SO₃), which may further react with NH₃ to produce ammonium bisulfate (ABS, NH₄HSO₄) that covers the catalyst-active sites and may shorten the catalyst lifespan.

The present disclosure generally relates to a method for regenerating the catalytic filter medium or filter bags in-situ by removing the formed ABS and recover the catalytic performance. According to some embodiments, the method depends on NO₂ being present in the flue gas stream while it flows through or flows by the catalytic filter bag. In certain embodiments, the catalytic article is used in a flow-through configuration, where gas or liquid is flowing transverse to (e.g., perpendicular to) a cross section of the catalytic article, such that the gas or liquid passes through the catalyst particle layer in the catalytic article. In yet certain embodiments, the catalytic article is used in a flow-by configuration, where gas or liquid is flowing parallel to the cross-section of the catalytic article, such that the gas or liquid is flowing parallel and diffuse to the catalyst particle in the catalytic layer, and does not pass through the cross section of the catalytic article. In some embodiments, the method includes increasing the upstream NO₂ concentration via introducing an oxidizing agent into the flue gas stream to oxidize NO to NO₂.

Depending on the compounds present in the flue gas, there may be interference with the desired conversion of NO into NO₂ and as a result, oxidizing agents, for example, ozone or H₂O₂, may not be able to generate enough NO₂ in the flue gas stream. According to some embodiments of the present disclosure, the method includes introducing additional NO₂ into the flue gas stream. NO₂ may be difficult to obtain for purpose of injection into a flue gas. In certain embodiments, the method includes generating NO₂ in-situ for injection into the flue gas stream.

In some embodiments, the method includes mixing NO with an oxidizing agent outside or separate from the flue gas duct to form NO₂, then injecting the mixed gas containing NO₂ into the flue gas duct upstream of the baghouse. As such, the efficacy of the oxidizing agent will not be impacted by the fly ash or one or more particulates in the flue gas.

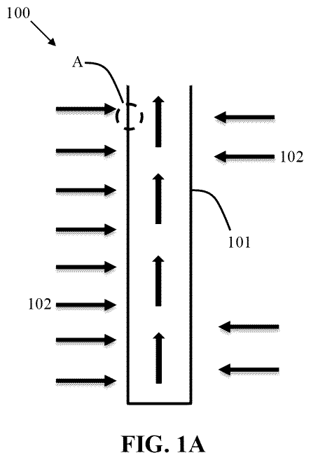

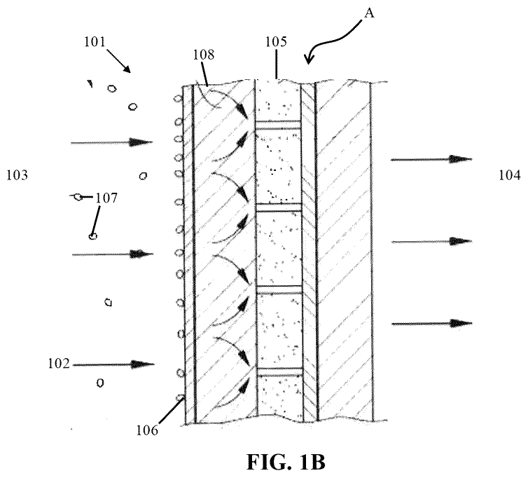

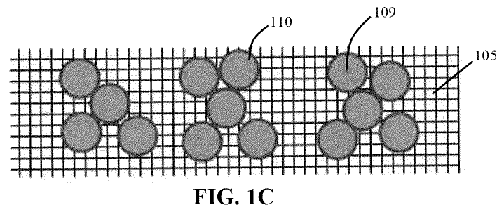

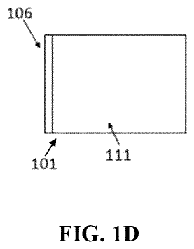

FIGS. 1A-1D are exemplary filter mediums according to embodiments of the present disclosure. As shown in FIG. 1A, filter medium 101 may be housed in a filter bag 100. A flue gas stream 102 may flow through the filter medium 101 by passing through cross section A. Once the flue gas stream 102 flows through the filter medium 101, the flue gas stream 102 may flow by the filter bag 100, as indicated by the vertically oriented arrows.

FIG. 1B depicts an exemplary filter medium 101 according to some embodiments of the present disclosure. As shown in FIG. 1B, a flue gas stream 102, which may include NOx compounds and solid particulates 107, may flow through cross section A from an upstream side 103 of the filter medium 101 to a downstream side 104 of the filter medium. While not shown, the upstream side 103 of the filter medium 101 may, in some embodiments, correspond to an outside of a filter bag, such as filter bag 100. Likewise, downstream side 104 of the filter medium 101 may correspond to an inside of a filter bag, such as filter bag 100. In some embodiments, filter medium 101 may include at least one protective membrane 106 and one or more felt batts 108 on at least one of: the upstream side 103 the of the filter medium 101, the downstream side 104 the of the filter medium 101, or any combination thereof. In some embodiments, the one or more felt batts 108 may be positioned on a porous catalytic film 105. In some embodiments, the combination of the one or more felt batts 108 and the porous catalytic film 105 may be collectively referred to as a porous catalytic layer.

FIG. 1C depicts an exemplary embodiment of the porous catalytic film 105. As shown, porous catalytic film 105 may include catalyst particles 109 on at least one surface of the porous catalytic film 105. ABS deposits 110 may be disposed on the surface of the catalyst particles 109.

FIG. 1D depicts an additional non-limiting exemplary embodiment of a filter medium 101. As shown, filter medium 101 may include a porous catalytic layer 111. In some non-limiting embodiments, filter medium 101 may take the form of a filter bag. In some embodiments the porous catalytic layer 111 may be coated with a catalyst material (not shown in FIG. 1D) such as catalyst particles. In some embodiments, the catalyst material may be attached to the porous catalytic layer 111 by one or more adhesives described herein (not shown in FIG. 1D). In some embodiments, the filter medium 101 may include a porous protective membrane 106.

The present disclosure generally relates to a method of regenerating at least one filter medium (e.g., filter medium 101 as shown in FIGS. 1A-1D) for improving catalytic efficiency. The method may be used to generate a filter medium for use in cleaning a flue gas stream.

According to some embodiments, the filter medium includes at least one catalyst material. In some embodiments, the at least one catalyst material may include, for example, Vanadium Monoxide (VO), Vanadium Trioxide (V₂O₃), Vanadium Dioxide (VO₂), Vanadium Pentoxide (V₂O₅), Tungsten Trioxide (WO₃), Molybdenum Trioxide (MoO₃), Titanium Dioxide (TiO₂), Silicon Dioxide (SiO₂), Aluminum Trioxide (Al₂O₃), Manganese Oxide (MnO₂), zeolites, or any combination thereof. In some embodiments, the at least one catalyst material is in the form of catalyst particles.

According to certain embodiments, the at least one filter medium includes an upstream side and a downstream side. In some embodiments, the at least one filter medium is disposed within at least one filter bag. In some embodiments, a plurality of filter mediums is disposed within a single filter bag. In some embodiments, the at least one filter bag is housed within at least one filter bag housing. In some embodiments, a plurality of filter bags is disposed within a single filter bag housing.

In some embodiments, the one filter medium includes a porous protective layer and a porous catalytic layer. In some embodiments, the porous catalytic layer includes at least one catalyst material. In some embodiments, the at least one catalyst material is disposed on the porous catalytic layer. In some embodiments, the at least one catalyst material is within (e.g., embedded within) the porous catalytic layer.

In certain embodiments, the porous protective layer includes a microporous layer. In some embodiments, the microporous layer includes an expanded polytetrafluoroethylene (ePTFE) membrane. In some embodiments, the at least one catalyst material is adhered to the filter medium by at least one adhesive. In some embodiments, the at least one catalyst material is adhered to the porous catalytic layer by at least one adhesive. In some exemplary embodiments, the at least one filter medium is in the form of a filter bag, such that the adherence of the at least one catalyst material to the porous catalytic layer by the at least one adhesive form a coated filter bag. In some embodiments, the at least one catalyst material is in the form of catalyst particles, such that the coated filter bag is coated with the catalyst particles.

In some embodiments, the at least one adhesive is chosen from polytetrafluoroethylene (PTFE), fluorinated ethylene propylene (FEP), high molecular weight polyethylene (HMWPE), high molecular weight polypropylene (HMWPP), perfluoroalkoxy alkane (PFA), polyvinylidene fluoride (PVDF), vinylidene fluoride (THV), chlorofluoroethylene (CFE), or any combination thereof. In some embodiments, the at least one adhesive is polytetrafluoroethylene (PTFE), fluorinated ethylene propylene (FEP), high molecular weight polyethylene (HMWPE), high molecular weight polypropylene (HMWPP), perfluoroalkoxy alkane (PFA), polyvinylidene fluoride (PVDF), vinylidene fluoride (THV), chlorofluoroethylene (CFE), or a combination thereof.

In some embodiments, the porous catalytic layer includes at least one polymeric substrate. In some embodiments, the at least one polymeric substrate includes at least one of: polytetrafluorethylene (PTFE), poly(ethylene-co-tetrafluoroethylene) (ETFE), ultra-high molecular weight polyethylene (UHMWPE), poly paraxylylene, polylactic acid, polyimide, polyamide, polyaramid, polyphenylene sulfide, fiberglass, or any combination thereof. In some embodiments, the at least one polymeric substrate is polytetrafluorethylene, poly(ethylene-co-tetrafluoroethylene), ultra-high molecular weight polyethylene, polyparaxylylene (PPX), polylactic acid, polyimide, polyamide, polyaramid, polyphenylene sulfide, fiberglass, and any combination thereof.

In some embodiments, the porous catalytic layer includes at least one ceramic substrate. In some embodiments, the at least one ceramic substrate is in the form of a ceramic candle described herein. In some embodiments, the one ceramic substrate includes ceramic fibers. In some embodiments, the ceramic fibers include alkali metal silicates, alkaline earth metal silicates, aluminosilicates, or any combination thereof.

In some embodiments, the porous catalytic layer is in the form of a layered assembly including a porous catalytic film and one or more felt batts. In some embodiments, the one or more felt batts are positioned on at least one side of the porous catalytic film. In some embodiments, the porous catalytic film includes the at least one catalyst material. In some embodiments, the at least one catalyst material is disposed on the porous catalytic film. In some embodiments, the at least one catalyst material is within (e.g., embedded within) the porous catalytic film.

In some embodiments, the one or more felt batts include at least one of: a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, or any combination thereof. In some embodiments, the one or more felt batts are a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, and any combination thereof.

In some embodiments, the porous catalytic film includes a membrane. In some embodiments, the porous catalytic film includes a polymer membrane. In some embodiments, the porous catalytic film includes a fluoropolymer membrane and may be referred to as a porous catalytic fluoropolymer film.

Non-limiting examples of suitable synthetic polymer membranes include polyurethanes, polytetrafluoroethylene (PTFE), expanded polytetrafluoroethylene (ePTFE), polyvinylidene fluoride (PVDF), fluorinated ethylene propylene (FEP), perfluoroalkoxy alkane (PFA), modified polytetrafluoroethylene polymers, tetrafluoroethylene (TFE) copolymers, polyalkylenes such as polypropylene and polyethylene, polyester sulfone (PES), polyesters, poly (p-xylylene) (ePPX) as taught in U.S. Patent Publication No. 2016/0032069, porous ultra-high molecular weight polyethylene (eUHMWPE) as taught in U.S. Pat. No. 9,926,416 to Sbriglia, porous ethylene tetrafluoroethylene (eETFE) as taught in U.S. Pat. No. 9,932,429 to Sbriglia, porous polylactic acid (ePLLA) as taught in U.S. Pat. No. 7,932,184 to Sbriglia, et al., porous vinylidene fluoride-co-tetrafluoroethylene or trifluoroethylene [VDF-co-(TFE or TrFE)] polymers as taught in U.S. Pat. No. 9,441,088 to Sbriglia and copolymers and combinations thereof. In at least one embodiment, the synthetic polymer membrane is a microporous synthetic polymer membrane, such as a microporous fluoropolymer membrane having a node and fibril microstructure where the nodes are interconnected by the fibrils and the pores are the voids or space located between the nodes and fibrils throughout the membrane. An exemplary node and fibril microstructure is described in U.S. Pat. No. 3,953,566 to Gore. In some embodiments, the porous catalytic film or porous catalytic layer includes an expanded polytetrafluoroethylene (ePTFE) membrane.

In some embodiments, the porous catalytic film or porous catalytic layer includes catalyst particles enmeshed within the porous catalytic layer, for example, the ePTFE membrane. In some embodiments, the ePTFE membrane has a microstructure that includes nodes, fibrils, or any combination thereof. In some embodiments, the catalyst particles may be enmeshed into the microstructure. In some embodiments, the catalyst particles may be enmeshed into the nodes. In some embodiments, the catalyst particles may be enmeshed into the fibrils. In some embodiments, the catalyst particles may be enmeshed into the nodes and fibrils.

In certain embodiments, the at least one filter medium may include a porous catalytic fluoropolymer film having an upstream side and a downstream side. The porous catalytic fluoropolymer film may include a plurality of perforations, wherein each of the plurality of perforations is a straight passageway from an entrance surface at the upstream side of the porous catalytic fluoropolymer film to an exit surface at the downstream side of the porous catalytic fluoropolymer film. An exemplary porous catalytic fluoropolymer film is described in U.S. Pat. No. 11,078,821 to Gore. In some embodiments, the straight passageway is configured to enhance flow therethrough as compared to flow via the pores of the material, and the straight passageway may have a diameter of 0.1 mm to 3 mm. In certain embodiments, a percent open area of the porous catalytic fluoropolymer film is from 0.14% to 50%.

In some embodiments, the at least one filter medium is in the form of a ceramic candle. In some embodiments, the ceramic candle includes at least one ceramic material. In some embodiments, the least one ceramic material is chosen from: silica-aluminate, calcium-magnesium-silicate, calcium-silicate fibers, or any combination thereof. In some embodiments, catalyst particles form a coating on the at least one ceramic material.

In some embodiments, the at least one filter medium may include any material configured to capture at least one of solid particulates, liquid aerosols, or any combination thereof from a flue gas stream. In some embodiments, the at least one filter medium is in the form of at least one of: a filter bag, a honeycomb, a monolith or any combination thereof.

In some embodiments, the at least one filter medium includes ammonium bisulfate (ABS) deposits, ammonium sulfate (AS) deposits, or any combination thereof. In some embodiments, ABS deposits are disposed on the at least one catalyst material of the at least one filter medium. In some embodiments, ABS deposits are disposed within the at least one catalyst material of the at least one filter medium.

In some embodiments, the ABS deposits are present in a concentration ranging from 0.01% to 99%, or from 0.1% to 99%, or from 1% to 99%, or from 10% to 99%, or from 25% to 99%, or from 50% to 99%, or from 75% to 99%, or from 95% to 99% by mass of the at least one filter medium, or may be present in a concentration encompassed within these ranges.

In some embodiments, the ABS deposits are present in a concentration ranging from 0.01% to 95%, or from 0.01% to 75%, or from 0.01% to 50%, or from 0.01% to 25%, or from 0.01% to 10%, or from 0.01% to 1%, or from 0.01% to 0.1% by mass of the at least one filter medium or may be present in a concentration encompassed within these ranges.

In some embodiments, the ABS deposits are present in a concentration ranging from 0.1% to 95%, or from 1% to 75%, or from 10% to 50% by mass of the at least one filter medium during the providing step.

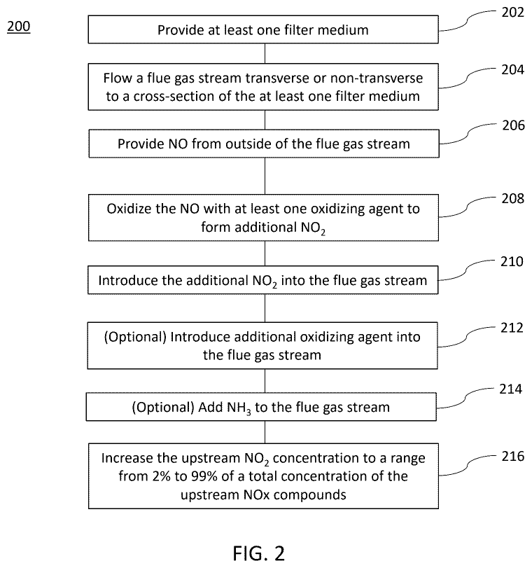

FIG. 2 is a flow diagram of a method 200 for regenerating at least one filter medium in accordance with embodiments of the present disclosure.

At step 202, the method 200 may include providing at least one filter medium. The at least one filter medium may include at least one catalyst material, and ammonium bisulfate (ABS) deposits, ammonium sulfate (AS) deposits, or any combination thereof. In certain embodiments, ABS deposits are disposed on the catalyst material of the at least one filter medium in a concentration ranging from 0.01% to 99% by mass of the at least one filter medium.

At step 204, the method 200 may include flowing a flue gas stream transverse to a cross-section of the at least one filter medium (i.e., transverse to a cross-section of the at least one filter medium), such that the flue gas stream passes through the cross section of the at least one filter medium. In some embodiments, the flue gas stream is flowed from an upstream side to a downstream side of the at least one filter medium. In some embodiments, flowing the flue gas stream transverse to the cross-section of the at least one filter medium includes flowing the flue gas stream perpendicular to a cross-section of the at least one filter medium.

In some embodiments, at step 204, the method 200 may include flowing a flue gas stream by the at least one filter medium (i.e., non-transverse to a cross-section of the at least one filter medium), such that the flue gas stream does not pass through the cross section of the at least one filter medium. In some embodiments, the flue gas stream is flowed parallel to a cross-section of the at least one filter medium.

In certain embodiments, at step 204, the temperature of the flue gas stream ranges from about 80° C. to about 450° C., or from about 90° C. to about 280° C., or from about 100° C. to about 280° C., or from about 110° C. to about 280° C., or from about 120° C. to about 280° C., or from about 130° C. to about 280° C., or from about 160° C. to 280° C., or may have a temperature encompassed within these ranges.

In some embodiments, at step 204, the temperature of the flue gas stream ranges from about 80° C. to about 250° C., or from about 80° C. to 225° C., or from about 80° C. to 200° C., or from about 80° C. to 175° C., or from about 80° C. to 150° C., or from about 80° C. to 125° C. or may have a temperature encompassed within these ranges.

In some embodiments where the at least one filter medium is in the form of or includes a ceramic substrate (e.g., a ceramic candle), at step 204, the temperature of the flue gas stream ranges from about 170° C. to about 450° C., or from about 200° C. to about 400° C., or from about 200° C. to 450° C., or from about 250° C. to about 450° C., or from about 300° C. to about 450° C., or from about 350° C. to about 450° C., or from about 400° C. to about 450° C., or may have a temperature encompassed within these ranges.

In some embodiments where the at least one filter medium is in the form of or includes a ceramic substrate (e.g., a ceramic candle), at step 204, the temperature of the flue gas stream ranges from about 170° C. to about 400° C., or from about 170° C. to 350° C., or from about 170° C. to about 300° C., or from about 170° C. to about 250° C., or from about 170° C. to about 200° C., or may have a temperature encompassed within these ranges. In some embodiments, such as embodiments where the at least one filter medium is in the form of or includes a ceramic substrate (e.g., a ceramic candle), the temperature of the flue gas stream ranges from 250° C. to 350° C. during the flowing step.

In some embodiments, the flue gas stream may include NOx compounds including Nitric Oxide (NO) and Nitrogen Dioxide (NO₂). In certain embodiments, the flue gas stream may include NOx compounds (e.g., Nitric Oxide (NO) and/or Nitrogen Dioxide (NO₂)), sulfur dioxide (SO₂) and ammonia (NH₃). In some embodiments, the flue gas stream may further include Oxygen (O₂), Water (H₂O), Nitrogen (N₂), Carbon Monoxide (CO), Sulfur Dioxide (SO₂), Sulfur Trioxide (SO₃), one or more hydrocarbons, or any combination thereof. In certain embodiments, the flue gas stream may include one or more particles, for example, fly ash (e.g., cement plant particles, oxides of silicon, aluminum, iron, and calcium, other metal salts, or any combination thereof), one or more dry absorbents (e.g., Ca(OH)₂, CaO, NaHCO₃, Na₂CO₃, or any combination thereof), dust, soot, ash, or the like, or sulfur particulates, or particulates that include a transition metal salt, or any combination thereof.

In some embodiments, the method 200 may include providing NO from outside of the flue gas stream at step 206, oxidizing the NO with at least one oxidizing agent to form NO₂ at step 208, and introducing the NO₂ into the flue gas stream at step 210. The NO₂ may be formed outside or separate from the flue gas stream. In certain embodiments, the NO is oxidized prior to being introduced into the flue gas stream. As the NO₂ is formed outside of the flue gas stream by oxidizing the NO with at least one oxidizing agent (e.g., ozone or H₂O₂), the fly ash and/or one or more particulates in the flue gas stream does not directly contact the oxidizing agent. As such, the fly ash and/or one or more particulates does not interfere with the oxidization of NO or prevent the formation of NO₂, thus further increasing the catalytic efficiency of the one or more filter medium. The concentration of NO is from 1 ppm to about 500000 ppm.

In an alternative embodiment to step 206, the providing the NO includes removing at least some of the NO from the flue gas stream and selectively filtering the at least some of the NO from the flue gas stream to obtain the NO. In some embodiments, the selective filtering removes one or more particulates, fly ash, or one or more dry absorbents from the NO removed from the flue gas stream.

In certain embodiments, the oxidizing the NO with at least one oxidizing agent to form NO₂ is at a temperature of from- 20° C. to 280° C. The at least one oxidizing agent may include hydrogen peroxide (H₂O₂), ozone (O₃), hydroxyl radical, an organic peroxide, a metal peroxide, a peroxy-acid, or any combination thereof. In some embodiments, the oxidizing the NO comprises reacting the NO with an excess amount of the at least one oxidizing agent.

In some embodiments, the at least one oxidizing agent comprises hydrogen peroxide, ozone, an organic peroxide, a metal peroxide, a peroxy-acid, or any combination thereof. Examples of at least one organic peroxide that may be suitable for some embodiments of the present disclosure include, but are not limited to, benzoyl peroxide, di-benzoyl peroxide, peroxyacetic acid, acetyl acetone peroxide, acetyl benzoyl peroxide, tert-butyl hydroperoxide, naphthoyl peroxide, di-(1-naphthoyl) peroxide, diacetyl peroxide, ethyl hydroperoxide, methyl ethyl ketone peroxide, methyl isobutyl ketone peroxide, or any combination thereof. Examples of at least one metal peroxide that may be suitable for some embodiments of the present disclosure include but are not limited to barium peroxide (BaO₂), sodium peroxide (Na₂O₂), or any combination thereof. Examples of at least one peroxy-acid that may be suitable for some embodiments of the present disclosure include, but are not limited to, peroxymonosulfuric acid (H₂SO₅), peroxynitric acid (HNO₄), peroxymonophosphoric acid (H₃PO₅), or any combination thereof.

At step 212, the method 200 may include optionally introducing additional oxidizing agent into the flue gas stream. At step 214, the method 200 may include optionally introducing or adding ammonia (NH₃) to the flue gas stream. The NH₃ added may have a concentration ranging from 0.0001% to 0.5% of a concentration of the flue gas stream.

At step 216, the method 200 of regenerating at least one filter medium may include increasing the upstream NO₂ concentration to a range from 2% to 99% of a total concentration of the upstream NOx compounds to increase the NOx removal efficiency of the at least one filter medium. In certain embodiments (not shown in FIG. 2), the increasing of the NOx removal efficiency further includes removing at least some of the ABS deposits, the AS deposits, or any combination thereof, from the at least one filter medium.

In some embodiments, the increasing of the NOx removal efficiency of the at least one filter medium includes increasing NO₂ concentration to a range from 2% to 99%, or from 5% to 99%, or from 10% to 99%, or from 25% to 99%, or from 50% to 99%, or from 75% to 99%, or from 95% to 99%, based on the total concentration of the NOx compounds in the flue gas, or may increase NO₂ concentration to a percentage encompassed within these ranges.

In some embodiments, the increasing of the NOx removal efficiency of the at least one filter medium includes increasing NO₂ concentration to a range from 2% to 95%, or from 2% to 75%, or from 2% to 50%, or from 2% to 25%, or from 2% to 10%, or from 2% to 5%, based on the total concentration of the NOx compounds in the flue gas, or may increase NO₂ concentration to a percentage encompassed within these ranges.

In some embodiments, the increasing of the NOx removal efficiency of the at least one filter medium includes increasing NO₂ concentration to a range from 5% to 95%, based on the total concentration of the NOx compounds in the flue gas. In some embodiments, the increasing of the NOx removal efficiency of the at least one filter medium includes increasing NO₂ concentration to a range from 10% to 75%, based on the total concentration of the NOx compounds in the flue gas. In some embodiments, the increasing of the NOx removal efficiency of the at least one filter medium includes increasing NO₂ concentration to a range from 25% to 50%, based on the total concentration of the NOx compounds in the flue gas.

In some embodiments, the increase of the upstream NO₂ concentration to a range from 2% to 99%, based on the total concentration of the upstream NOx compounds in the flue gas may be a result of steps 206, 208, and 210. In some embodiments, the increase of the upstream NO₂ concentration to a range from 2% to 99%, based on the total concentration of the upstream NOx compounds in the flue gas may be a result of steps 206, 208, 210, and 212.

In some embodiments, after increasing the upstream NO₂ concentration to a range from 2% to 99%, based on the of a total concentration of the upstream NOx compounds in the flue gas in step 216, ABS deposits are disposed on the catalyst material of the at least one filter medium in a concentration ranging from 0.01% to 98% by mass of the at least one filter medium.

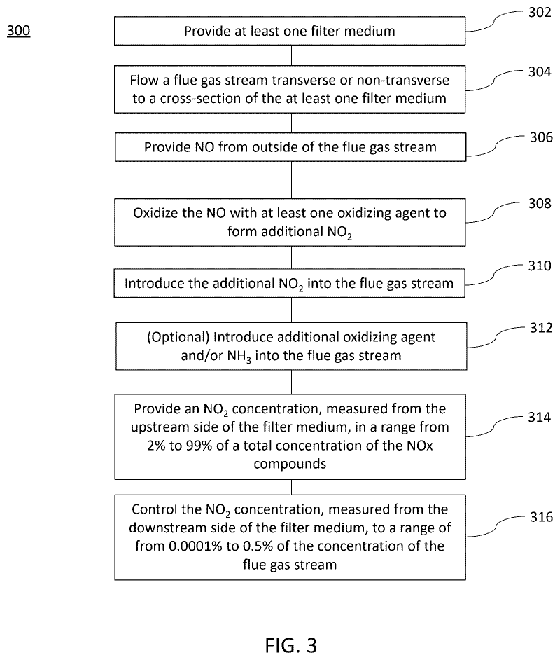

FIG. 3 is a flow diagram of a method 300 for regenerating at least one filter medium in accordance with embodiments of the present disclosure.

At step 302, the method 300 may include providing at least one filter medium. The at least one filter medium may include at least one catalyst material, and ammonium bisulfate (ABS) deposits, ammonium sulfate (AS) deposits, or any combination thereof. In certain embodiments, ABS deposits are disposed on the catalyst material of the at least one filter medium in a concentration ranging from 0.01% to 99% by mass of the at least one filter medium.

At step 304, the method 300 may include flowing a flue gas stream transverse to a cross-section of the at least one filter medium (i.e., transverse to a cross-section of the at least one filter medium), such that the flue gas stream passes through the cross section of the at least one filter medium. In some embodiments, the flue gas stream is flowed from an upstream side to a downstream side of the at least one filter medium. In some embodiments, flowing the flue gas stream transverse to the cross-section of the at least one filter medium includes flowing the flue gas stream perpendicular to a cross-section of the at least one filter medium.

In certain embodiments, the temperature of the flue gas stream ranges from 80° C. to 450° C. In some embodiments, the temperature of the flue gas stream ranges from 160° C. to 280° C. during the flowing step. In some embodiments, the temperature of the flue gas stream ranges from 175° C. to 280° C. during the flowing step. In some embodiments, the temperature of the flue gas stream ranges from 200° C. to 280° C. during the flowing step. In some embodiments, the temperature of the flue gas stream ranges from 225° C. to 280° C. during the flowing step. In some embodiments, the temperature of the flue gas stream ranges from 250° C. to 280° C. during the flowing step.

In some embodiments, the flue gas stream may include NOx compounds (e.g., Nitric Oxide (NO) and/or Nitrogen Dioxide (NO₂)), sulfur dioxide (SO₂) and ammonia (NH₃). In some embodiments, the flue gas stream may further include Oxygen (O₂), Water (H₂O), Nitrogen (N₂), Carbon Monoxide (CO), Sulfur Dioxide (SO₂), Sulfur Trioxide (SO₃), one or more hydrocarbons, or any combination thereof. In certain embodiments, the flue gas stream may include one or more particles, for example, fly ash (e.g., cement plant particles, oxides of silicon, aluminum iron and calcium, other metal salts, or any combination thereof), dry absorbents (e.g., Ca(OH)₂, CaO, NaHCO₃, Na₂CO₃, or any combination thereof), dust, soot, ash, or the like, or sulfur particulates, or particulates that include a transition metal salt, or any combination thereof.

In some embodiments, the method 300 may include providing NO from outside of the flue gas stream at step 306, oxidizing the NO with at least one oxidizing agent to form NO₂ at step 308, and introducing the NO₂ into the flue gas stream at step 310. The NO₂ may be formed outside of the flue gas stream. In certain embodiments, the NO is oxidized prior to being introduced into the flue gas stream. As the NO₂ is formed outside of the flue gas stream by oxidizing the NO with at least one oxidizing agent (e.g., ozone or H₂O₂, or any of the organic peroxide, metal peroxide or peroxy-acid listed above), the fly ash and/or one or more particulates in the flue gas stream does not directly contact the oxidizing agent. As such, the fly ash and/or one or more particulates does not interfere with the oxidization of NO or prevent the formation of NO₂, thus further increasing the catalytic efficiency of the one or more filter medium.

In an alternative embodiment to step 306, the providing the NO includes removing at least some of the NO from the flue gas stream and selectively filtering the at least some of the NO from the flue gas stream to obtain the NO. In some embodiments, the selective filtering removes one or more particulates, fly ash, or one or more dry absorbents from the NO removed from the flue gas stream.

In certain embodiments, the oxidizing the NO with at least one oxidizing agent to form additional NO₂ is at a temperature of from about −20° C. to about 280° C., or from about −10° C. to about 260° C., or from about 0° C. to about 240° C., or from about 10° C. to about 220° C., or from about 20° C. to about 200° C., or from about 30° C. to about 180° C., or from about 40° C. to about 160° C., or from about 50° C. to about 140° C., or from about 65° C. to about 130° C., or from about 80° C. to about 120° C. The at least one oxidizing agent may include hydrogen peroxide (H₂O₂), ozone (O₃), hydroxyl radical, an organic peroxide, a metal peroxide, a peroxy-acid or any combination thereof. In some embodiments, the oxidizing the NO includes reacting the NO with an excess amount of the at least one oxidizing agent.

At step 312, the method 300 may include optionally introducing additional oxidizing agent and/or NH₃ into the flue gas stream. The NH₃ added may have a concentration ranging from 0.0001% to 0.5% of a concentration of the flue gas stream.

At step 314, the method 300 may include providing an NO₂ concentration, measured from the upstream side of the filter medium, in a range from 2% to 99% of a total concentration of the NOx compounds. Providing an NO₂concentration in a range from 2% to 99% of a total concentration of the NOx compounds on the upstream side of the filter medium may maintain a NOx removal efficiency of the at least one filter medium in an amount of at least 50% of an initial NOx removal efficiency of the at least one filter medium.

In some embodiments, providing an NO₂ concentration in a range from 2% to 99% of a total concentration of the NOx compounds on the upstream side of the filter medium may maintain a NOx removal efficiency of the at least one filter medium in an amount of from about 50% to about 97%, or from about 60% to about 97%, or from about 70% to about 97%, or from about 75% to about 96%, or from about 80% to about 95% of an initial NOx removal efficiency of the at least one filter medium, or may be maintained at a percentage encompassed within these ranges.

In some embodiments, the providing the NO₂ concentration, measured from the upstream side of the filter medium, in a range from 2% to 99% of a total concentration of the NOx compounds may be a result of steps 306, 308, and 310. In some embodiments, the providing the NO₂ concentration, measured from the upstream side of the filter medium, in a range from 2% to 99% of a total concentration of the NOx compounds may be a result of steps 306, 308, 310, and 312.

At step 316, the method 300 may further include controlling the NO₂concentration, measured from the downstream side of the filter medium, to a range of from 0.0001% to 0.5% of the concentration of the flue gas stream.

In some embodiments, a method for cleaning a flue gas stream includes the method 200 or method 300.

According to some embodiments, a system includes at least one filter medium, at least one filter bag, and at least one filter bag housing. The at least one filter medium is disposed within the at least one filter bag, and the at least one filter bag is disposed within the at least one filter bag housing. In some embodiments, the at least one filter medium includes an upstream side, a downstream side, at least one catalyst material, and ammonium bisulfate (ABS) deposits, ammonium sulfate (AS) deposits, or any combination thereof. In some embodiments, the at least one filter bag housing is configured to receive a flow of a flue gas stream transverse to a cross-section of the at least one filter medium, such that the flue gas stream passes through the cross section of the at least one filter medium from the upstream side of the at least one filter medium to the downstream side of the at least one filter medium. The flue gas stream may include NOx compounds including Nitric Oxide (NO) and Nitrogen Dioxide (NO₂).

In certain embodiments, the system is configured to increase an NOx removal efficiency of the at least one filter medium when an upstream NO₂ concentration is increased to a range from 2% to 99% of a total concentration of the upstream NOx compounds. In some embodiments, increasing the upstream NO₂ concentration to a range from 2% to 99% of a total concentration of the upstream NOx compounds includes providing NO, oxidizing the NO with at least one oxidizing agent to form additional NO₂, and introducing the additional NO₂ into the flue gas stream.

### EXAMPLES

### Example 1 (Without Ozone)

A gas mixture containing 13 cc/min 10% NO in N₂, 1750 cc/min N₂, and 75 cc/min O₂ were mixed at room temperature and set to flow-through a reactor with 8% water moisture. The gas phase NO and NO₂ concentration were monitored with a MKS MULTI-GAS 2030D FTIR analyzer. The measured NO concentration was 579 ppm and NO₂ concentration was 18 ppm. The NO₂ concentration in NOx was 3%.

### Example 2: No Injected Into Ozone Gas Stream

A gas mixture containing 13 cc/min 10% NO in N₂, 1750 cc/min N₂, and 75 cc/min 0.64% O₃ in O₂ (O₂ concentration is 99.36%) were mixed at room temperature and set to flow-through a reactor with 8% water moisture. The gas phase NO and NO₂ concentration were monitored with a MKS MULTI-GAS 2030D FTIR analyzer. The measured NO concentration was 295 ppm and NO₂ concentration was 305 ppm. The NO₂ concentration in NOx was increased to 50.8% by oxidizing NO with O₃. The 0.64% O₃ in O₂ was generated from the TG-20 O₃ generator.

### Example 3: NO₂ Regeneration of Catalyst

At an industrial cement production plant comprising a filtration baghouse assembly, a reaction pipeline is installed so that the contents of the reaction pipeline is added to the flue gas upstream of the filter bag assembly. An NO source and an ozone source are added to the reaction pipeline.

Under normal cement plant operating conditions, when the concentration of ammonium bisulfate and/or ammonium sulfate reaches a limit on the catalyst, the NO source and the ozone source are initiated so that approximately equimolar amounts of NO and ozone are mixed in the reaction pipeline forming NO₂. The NO₂ is formed in the reaction pipeline and enters the flue gas upstream of the baghouse. The increased concentration of NO₂ regenerates the catalyst by removing the ammonium bisulfate and/or ammonium sulfate.

The disclosure of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this disclosure provided they come within the scope of the appended claims and their equivalents.

1. A method comprising:
providing at least one filter medium;
wherein the at least one filter medium comprises:
at least one catalyst material; and
ammonium bisulfate (ABS) deposits, ammonium sulfate (AS) deposits, or any combination thereof;
flowing a flue gas stream transverse to a cross-section of the at least one filter medium, such that the flue gas stream passes through the cross section of the at least one filter medium,
wherein the flue gas stream comprises:
NOx compounds comprising:
Nitric Oxide (NO), and
Nitrogen Dioxide (NO₂); and
increasing NOx removal efficiency of the at least one filter medium;
wherein the increasing of the NOx removal efficiency of the at least one filter medium comprises increasing an upstream NO₂ concentration to a range from 2% to 99% of a total concentration of the upstream NOx compounds,
wherein the increasing the upstream NO₂ concentration to a range from 2% to 99% of a total concentration of the upstream NOx compounds comprises:
providing an NO stream;
oxidizing the NO stream with at least one oxidizing agent to form additional NO₂, and
introducing the additional NO₂ into the flue gas stream; and optionally wherein the NO stream is oxidized prior to being introduced into the flue gas stream.

2. (canceled)

3. The method of claim 1, wherein the providing the NO stream comprises removing at least some of the NO from the flue gas stream and selectively filtering the at least some of the NO from the flue gas stream to obtain the NO stream, and optionally wherein increasing the upstream NO₂ concentration to a range from 2% to 99% of a total concentration of the upstream NOx compounds further comprises: introducing additional oxidizing agent into the flue gas stream.

4. (canceled)

5. The method of claim 1, wherein the method regenerates the at least one filter medium.

6. The method of claim 1, wherein oxidizing the NO stream with at least one oxidizing agent to form additional NO₂ is at a temperature of from −20 C. to 280° C., optionally wherein the oxidizing the NO stream comprises reacting the NO stream with an excess amount of the at least one oxidizing agent.

7. The method of claim 1, wherein the at least one oxidizing agent is hydrogen peroxide (H₂O₂), ozone (O₃), hydroxyl radical, an organic peroxide, a metal peroxide, a peroxy-acid, or any combination thereof.

8. (canceled)

9. The method of claim 1, wherein a temperature of the flue gas stream ranges from 80 C. to 450 C. during the flowing step, optionally wherein the temperature of the flue gas stream ranges from 160 C. to 280 C.

10. (canceled)

11. The method of claim 1, wherein the flue gas stream further comprises Oxygen (O₂), Water (H₂O), Nitrogen (N₂), Carbon Monoxide (CO), Sulfur Dioxide (SO₂), Sulfur Trioxide (SO₃), one or more hydrocarbons, one or more particulates or any combination thereof, optionally wherein flowing the flue gas stream transverse to the cross-section of the at least one filter medium comprises flowing the flue gas stream perpendicular to the cross-section of the at least one filter medium.

12. (canceled)

13. The method of claim 1, wherein the at least one filter medium is disposed within at least one filter bag, wherein the at least one filter bag is housed within at least one filter bag housing, and wherein the at least one catalyst material is in the form of catalyst particles, optionally wherein the at least one filter medium comprises:
a porous protective layer; and
a porous catalytic layer, wherein the porous catalytic layer comprises the catalyst particles.

14. (canceled)

15. The method of claim 13, wherein the porous protective layer of the at least one filter medium comprises a microporous layer, wherein the microporous layer comprises an expanded polytetrafluoroethylene (ePTFE) membrane, optionally wherein the porous catalytic layer of the at least one filter medium comprises at least one polymeric substrate or wherein the porous catalytic layer comprises at least one ceramic substrate.

16.-17. (canceled)

18. The method of claim 13, wherein the porous catalytic layer comprises polytetrafluorethylene (PTFE), poly(ethylene-co-tetrafluoroethylene) (ETFE), ultra-high molecular weight polyethylene (UHMWPE), polyparaxylylene (PPX), polylactic acid, polyimide, polyamide, polyaramid, polyphenylene sulfide, fiberglass, or any combination thereof, optionally wherein the catalyst particles are enmeshed within the porous catalytic layer.

19. (canceled)

20. The method of claim 13, wherein the porous catalytic layer is in the form of a layered assembly comprising:
a porous catalytic film; and
at least one felt batt, wherein the at least one felt batt is positioned on at least one side of the porous catalytic film.

21. The method of claim 20, wherein the porous catalytic film comprises an expanded polytetrafluoroethylene (ePTFE) membrane, optionally wherein the at least one felt batt comprises: a polytetrafluoroethylene (PTFE) felt, a PTFE fleece, an expanded polytetrafluoroethylene (ePTFE) felt, an ePTFE fleece, a woven fluoropolymer staple fiber, a nonwoven fluoropolymer staple fiber, or any combination thereof.

22. (canceled)

23. The method of claim 1, wherein the at least one catalyst material comprises at least one of: Vanadium Monoxide (VO), Vanadium Trioxide (V₂O₃), Vanadium Dioxide (VO₂), Vanadium Pentoxide (V₂O₅), Tungsten Trioxide (WO₃), Molybdenum Trioxide (MoO₃), Titanium Dioxide (TiO₂), Silicon Dioxide (SiO₂), Aluminum Trioxide (Al₂O₃), Manganese Oxide (MnO₂), zeolites, or any combination thereof.

24. The method of claim 1, wherein ABS deposits are disposed on the catalyst material of the at least one filter medium in a concentration ranging from 0.01% to 99% by mass of the at least one filter medium during the providing step. optionally wherein after increasing the upstream NO₂ concentration to a range from 2% to 99% of a total concentration of the upstream NOx compounds, ABS deposits are disposed on the catalyst material of the at least one filter medium in a concentration ranging from 0.01% to 98% by mass of the at least one filter medium.

25. (canceled)

26. The method of claim 1, wherein the at least one oxidizing agent is O₃ or H₂O₂.

27. (canceled)

28. The method of claim 1, wherein the increasing of the NOx removal efficiency further comprises removing at least some of the ABS deposits, the AS deposits, or any combination thereof, from the at least one filter medium.

29. The method of claim 1, further comprising adding ammonia (NH₃) to the flue gas stream, optionally wherein the NH₃ added has a concentration ranging from 0.0001% to 0.5% of a concentration of the flue gas stream.

30. (canceled)

31. A method comprising:
providing at least one filter medium
wherein the at least one filter medium comprises at least one catalyst material;
flowing a flue gas stream transverse to a cross-section of the at least one filter medium, such that the flue gas stream passes through the cross section of the at least one filter medium from an upstream side of the filter medium to a downstream side of the filter medium;
wherein the flue gas stream comprises:
NOx compounds comprising:
Nitric Oxide (NO), and
Nitrogen Dioxide (NO₂);
Sulfur Dioxide (SO₂); and
Ammonia (NH₃);
maintaining a NOx removal efficiency of the at least one filter medium in an amount of at least 50% of an initial NOx removal efficiency of the at least one filter medium by:
providing an NO₂ concentration, measured from the upstream side of the filter medium, in a range from 2% to 99% of a total concentration of the NOx compounds, wherein providing the NO₂ concentration, measured from the upstream side of the filter medium, in a range from 2% to 99% of a total concentration of the NOx compounds comprises:
providing an NO stream;
oxidizing the NO stream with at least one oxidizing agent to form additional NO₂, and
introducing the additional NO₂ into the flue gas stream; and
controlling the NO₂ concentration, measured from the downstream side of the filter medium, to a range of from 0.0001% to 0.5% of the concentration of the flue gas stream.

32. (canceled)

33. The method of claim 1, wherein the at least one filter medium comprises:
a porous catalytic fluoropolymer film having an upstream side and a downstream side,
wherein the porous catalytic fluoropolymer film comprises a plurality of perforations,
wherein each of the plurality of perforations is a straight passageway from an entrance surface at the upstream side of the porous catalytic fluoropolymer film to an exit surface at the downstream side of the porous catalytic fluoropolymer film,
i) wherein the straight passageway is configured to enhance flow therethrough as compared to flow via the pores of the material, and
ii) wherein the straight passageway has a diameter of 0.1 mm to 3 mm;
wherein a percent open area of the porous catalytic fluoropolymer film is from 0.14% to 50%.

34. A system comprising:
at least one filter medium,
wherein the at least one filter medium comprises:
an upstream side;
a downstream side;
at least one catalyst material; and
ammonium bisulfate (ABS) deposits, ammonium sulfate (AS) deposits, or any combination thereof;
at least one filter bag,
wherein the at least one filter medium is disposed within the at least one filter bag; and
at least one filter bag housing,
wherein the at least one filter bag is disposed within the at least one filter bag housing;
wherein the at least one filter bag housing is configured to receive a flow of a flue gas stream transverse to a cross-section of the at least one filter medium, such that the flue gas stream passes through the cross section of the at least one filter medium from the upstream side of the at least one filter medium to the downstream side of the at least one filter medium,
wherein the flue gas stream comprises:
NOx compounds comprising:
Nitric Oxide (NO), and
Nitrogen Dioxide (NO₂); and
wherein the system is configured to increase an NOx removal efficiency of the at least one filter medium when an upstream NO₂ concentration is increased to a range from 2% to 99% of a total concentration of the upstream NOx compounds,
wherein increasing the upstream NO₂ concentration to a range from 2% to 99% of a total concentration of the upstream NOx compounds comprises:
providing an NO stream;
oxidizing the NO stream with at least one oxidizing agent to form additional NO₂, and
introducing the additional NO₂ into the flue gas stream.
